(19) United States
(12) Patent Application Publication
(10) Pub. No.: US 2005/0046279 A1
(43) Pub. Date: Mar. 3, 2005

(54) Steering wheel high beam switch

(76) Inventor: Randolph Dunn, Weems, VA (US)

Correspondence Address: LITMAN LAW OFFICES, LTD., P.O. BOX 15035 CRYSTAL CITY STATION, ARLINGTON, VA, 22215, US

(21) Appl. No.: 10/648,204

(22) Filed: Aug. 27, 2003

(51) Int. Cl. B60L 3/00

(52) U.S. Cl. 307/10.8

(57) ABSTRACT

The steering wheel high beam switch provides a switch at the ten and/or two o'clock position on a steering wheel to permits a driver to quickly locate the high beam switch of a vehicle and turn on the high beams without removing hands from the steering wheel. The switch is positioned in a recess on the backside of the steering wheel not visible to a driver. Wiring through the steering wheel connects the switch with the vehicle's headlight switch, the high and low beams of the vehicle and the high beam indicator lamp in the vehicle's dashboard display.

### BACKGROUND OF THE INVENTION

1. Field of the Invention

The present invention relates to steering wheels and more particularly to steering wheels having controls for activating other vehicle systems.

2. Description of the Related Art

For the comfort and convenience of the drivers of vehicles, vehicle manufacturers have placed controls for the operation of the vehicle's windshield wipers, high beams and other accessories on the dash and steering columns of vehicles. Some have placed controls on the steering wheel of the vehicle. In the U.S. Pat. No. 4,616,224 issued Oct. 7, 1986 to Reighard, a multifunction steering wheel is taught where the controls for a plurality of vehicle functions are placed on a control pad attached to center of the vehicle's steering wheel. To operate the controls the driver must remove one hand from the steering wheel and search for a particular control. In U.S. Patent Application Publication no. 2003/0023353 A1 published Jan. 30, 2003 to Badarneh, at least two multifunction switches are mounted on opposite sides of a vehicle steering wheel. These switches may be mounted on opposing spokes of a steering wheel or at the ten and two o'clock positions so that a driver doesn't have to remove any hand from the steering wheel to operate different vehicle functions. The switches are actuated in an interactive fashion with the aid of indications or markings on a dashboard display. This arrangement requires the driver to direct attention from the road and further requires the use of processors and means for encoding and decoding signals.

The U.S. Pat. No. 4,835,512 issued May 30, 1989 to Bratton teaches providing a high beam indicator lamp in a recess in the top center portion of the vehicle's steering wheel. The wiring is routed through the rim and spokes of the steering wheel. Wiring is routed to the steering column in a manner as the wiring for the horn.

None of the above inventions and patents, taken either singly or in combination, is seen to describe the instant invention as claimed. Thus a steering wheel high beam switch solving the aforementioned problems is desired.

### SUMMARY OF THE INVENTION

The steering wheel high beam switch of the present invention provides a switch at the ten and/or two o'clock position to permits a driver to quickly locate the high beam switch of a vehicle and turn on the high beams without removing hands from the steering wheel. The switch is positioned in a recess on the backside of the steering wheel not visible to a driver. Wiring through the steering wheel connects the switch with the vehicle's headlight switch, the high and low beams of the vehicle and the high beam indicator lamp in the vehicle's dashboard display.

Accordingly, it is a principal object of the invention to provide steering wheel high beam switch on the rim of a steering wheel.

It is another object of the invention to provide a steering wheel high beam switch that can be activated without the driver moving a hand from the steering wheel.

It is a further object of the invention to allow a driver to more quickly locate and actuate the high beams of a vehicle.

Still another object of the invention is to provide a high beam switch remote from the on/off switch for the lights of a vehicle.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a steering wheel having the high beam switch according to the present invention.

FIG. 2 is a back view of a portion of a steering wheel provided with a push button switch position in a recess.

FIG. 3 is a back view of a portion of a steering wheel provided with a toggle switch position in a recess.

FIG. 4 is a schematic showing a single high beam switch.

FIG. 5 is a schematic showing the wiring for a pair of high beam switches.

Similar reference characters denote corresponding features consistently throughout the attached drawings.

### DETAILED DESCRIPTION OF THE PREFERRED EMBODIMENTS

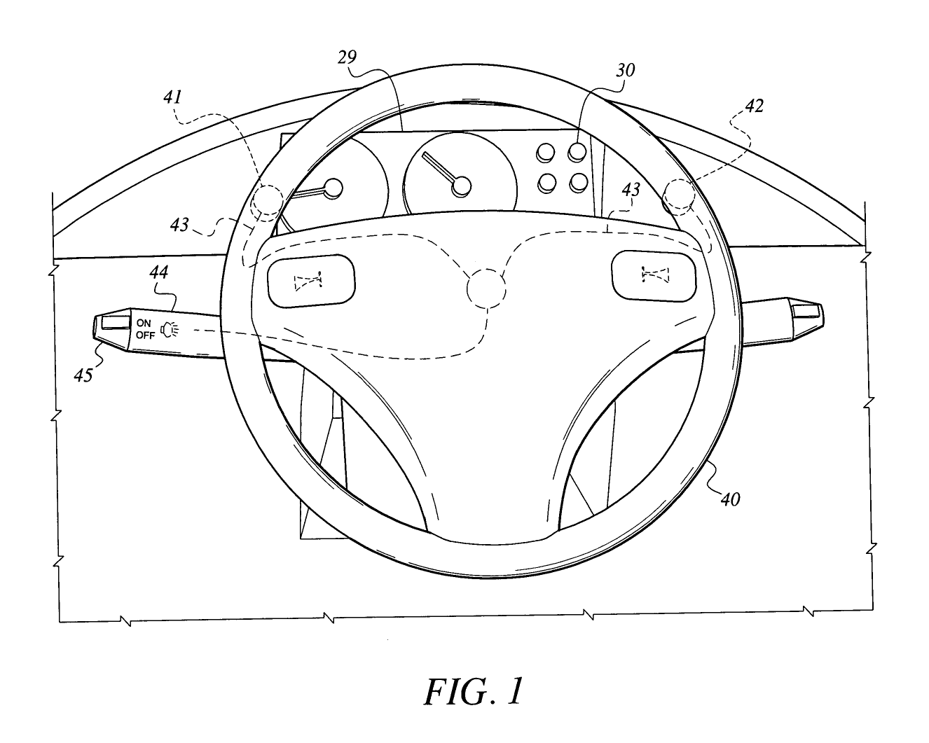

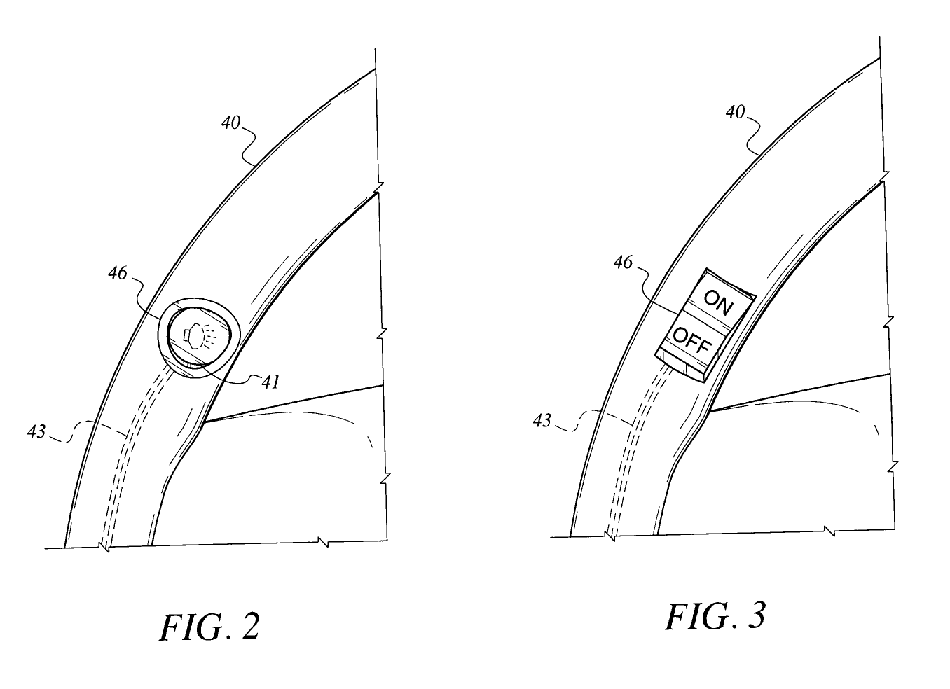

The present invention provides a conventional steering wheel 40 as seen in FIG. 1 with one or more high beam switches 41,42. One or more switches are positioned at the ten and/or two o'clock positions of the steering wheel 40 to permit a driver to quickly locate the high beam switches 41,42 and turn on the high beams 52 without removing hands from the steering wheel 40. Each switch 42,42 is positioned in a recess 46 on the backside of the steering wheel not visible to a driver as shown in FIGS. 2 and 3. The switches 41,42 may be placed at the three and nine o'clock positions or five and seven o'clock positions of steering wheel 40. The high beam switches 41, 42 may be of any suitable type such as contact, pushbutton, rotary, sliding or toggle.

Wiring 43 is provided through the steering wheel 40 for connecting high beam switches 41,42 with the vehicle's on/off headlight switch 45, to the high beams 52 and low beams 50 of the vehicle and to the high beam indicator 30 on the vehicle's dashboard display 29. The wiring 43 is passed through channels formed in the steering wheel 40 that open into the recesses 46 receiving the high beam switches 41, 42.

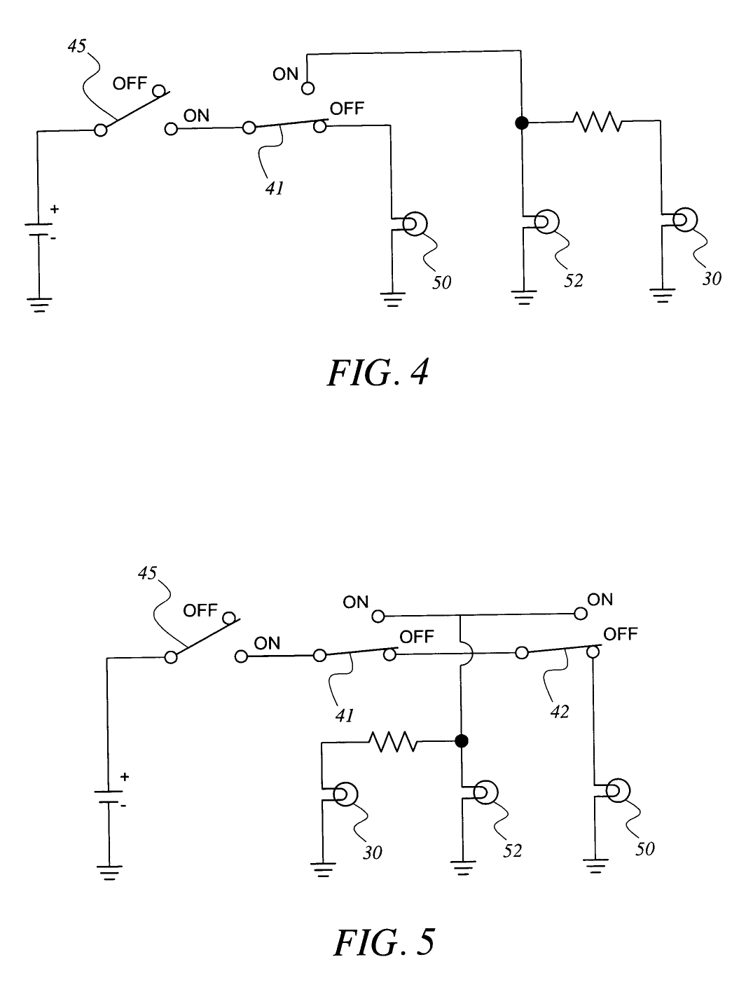

FIG. 4 shows that high beam switch 41 is connected by wiring 43 to the on/off headlight switch 45 of the vehicle. The other side of the on/off headlight switch 45 is connected to the vehicle power source. Headlight switch 45 may be at any typical location in the vehicle such as on a control stalk 44 or on the vehicle dashboard. High beam switch 41 is further connected to the high beams 52, low beams 50 and a high beam indicator 30 on a vehicle's dashboard display 29 in any suitable fashion. FIG. 5 shows a schematic diagram illustrating the connections when two high beam switches 41, 42 are used instead of one as shown in FIG. 4.

After a driver turns on the headlight switch 45 of a vehicle to activate the low beams 50, the high beams 52 can be quickly actuated and the low beams 50 turned off at any time while driving without moving one's hands from the steering wheel. The high beam switches 41, 42 may also be placed at other suitable locations on steering wheel 40, such as at the three and nine o'clock positions or the five and seven o'clock positions.

It is to be understood that the present invention is not limited to the embodiments described above, but encompasses any and all embodiments within the scope of the following claims.

1. A steering wheel high beam switch, comprising:
a steering wheel for a vehicle having a front face and a back face, at least one recess provided in the back face of said steering wheel;
a high beam switch positioned within said at least one recess, said high beam switch having three terminals
wiring passing through said steering wheel for operatively connecting a first terminal of said high beam switch to one terminal of a headlight switch, operatively connecting a second terminal of said high beam switch to low beams of said vehicle, and further operatively connecting a third terminal of said high beam switch to high beams of said vehicle and an indicator light on a dashboard display of said vehicle.

2. The steering wheel high beam switch according to claim 1, further comprising:
a second high beam switch positioned within a second recess, said second high beam switch having three terminals;
said wiring also provides for operatively connecting a first terminal of said second high beam switch to said one terminal of said headlight switch, operatively connecting a second terminal of said second high beam switch to said low beams of said vehicle, and further operatively connecting a third terminal of said second high beam switch to said high beams of said vehicle and said indicator light on the dashboard display of said vehicle.

3. The steering wheel high beam switch according to claim 1, wherein said high beam switch is a push button switch.

4. The steering wheel high beam switch according to claim 1, wherein said high beam switch is a toggle switch.

5. The steering wheel high beam switch according to claim 1, wherein said high beam switch is a contact switch.

6. The steering wheel high beam switch according to claim 1, wherein said high beam switch is a sliding switch.

7. The steering wheel high beam switch according to claim 2, wherein said high beam switches are push button switches.

8. The steering wheel high beam switch according to claim 2, wherein said high beam switches are toggle switches.

9. The steering wheel high beam switch according to claim 2, wherein said high beam switches are sliding switches.

10. The steering wheel high beam switch according to claim 2, wherein said high beam switches are contact switches.
